(19) United States
(12) Patent Application Publication
(10) Pub. No.: US 2017/0052362 A1
(43) Pub. Date: Feb. 23, 2017

(54) PHOSPHOR WHEEL AND WAVELENGTH CONVERTING DEVICE APPLYING THE SAME

(71) Applicant: DELTA ELECTRONICS, INC., Taoyuan City (TW)

(72) Inventors: Yen-I CHOU, Taoyuan City (TW); Chi CHEN, Taoyuan City (TW); Chun-Hsien LU, Taoyuan City (TW)

(21) Appl. No.: 14/956,371

(22) Filed: Dec. 1, 2015

(30) Foreign Application Priority Data
Aug. 21, 2015 (TW) 104127276

(51) Int. Cl. G02B 26/00; G03B 21/20; G02B 1/11; F21V 13/08; G02B 27/14

(52) U.S. Cl. CPC G02B 26/008; F21V 13/08; G02B 27/141; G02B 1/11; G03B 21/204

(57) ABSTRACT

A phosphor wheel includes a first optical unit, a second optical unit, and a clamping component. The first optical unit includes a substrate and an optical layer. The optical layer is disposed on the substrate. The second optical unit is stacked on the optical layer, in which the optical layer is configured to at least reflect light beams propagated from the second optical unit. The second optical unit includes a transparent substrate and a phosphor layer. The phosphor layer is disposed on the transparent substrate. The first optical unit and the second optical unit are fixed by the clamping component.

### RELATED APPLICATIONS

This application claims priority to Taiwanese Application Serial Number 104127276, filed Aug. 21, 2015, which is herein incorporated by reference.

### BACKGROUND

Technical Field

The present disclosure relates to a phosphor wheel and a wavelength converting device applying the same

Description of Related Art

In recent years, optical projectors have been applied in many fields. The optical projectors have served an expanded range of purposes, for example, from use in consumer products to high-tech devices. Some kinds of optical projectors are widely used in schools, homes and business occasions in order to amplify image signals provided by an image signal source and then display on a projection screen. Nowadays, light sources of the optical projectors, such as high-pressure mercury-vapor lamp, tungsten-halogen lamps, and metal-halogen lamps, are known to have high power consumption, with a short lifetime, as well they are bulky, and generate high heat.

For the purpose of reducing the power consumption and the size of devices, a solid-state light-emitting element is employed in a light source module of the optical projector to replace the high power lamp described above. With the development of the optical projectors, a laser light source and a phosphor wheel have been utilized in the light source module for providing light beams with various wavelengths.

### SUMMARY

An aspect of the present disclosure provides a wavelength converting device. In a configuration of the wavelength converting device, a first optical unit and a second optical unit stacked thereon can be fixed by a clamping component to assemble a phosphor wheel, and therefore an air medium is at least present between the second optical unit and an optical layer. With this air medium, the optical layer can have higher reflection efficiency with respect to light beams propagated from the second optical unit, especially a light beam with a great incident angle, such that a light emission efficiency of the phosphor wheel can be correspondingly increased.

An aspect of the present disclosure provides a phosphor wheel including a first optical unit, a second optical unit, and a clamping component. The first optical unit includes a substrate and an optical layer. The optical layer is disposed on the substrate. The second optical unit is stacked on the optical layer, in which the optical layer is configured to at least reflect light beams propagated from the second optical unit. The second optical unit includes a transparent substrate and a phosphor layer. The phosphor layer is disposed on the transparent substrate. The first optical unit and the second optical unit are fixed by the clamping component.

In some embodiments, the transparent substrate is disposed between the phosphor layer and the optical layer.

In some embodiments, the phosphor layer is disposed between the transparent substrate and the optical layer.

In some embodiments, the phosphor layer is excited by a first light beam with a first waveband to provide a second light beam with a second waveband, in which the optical layer is used for allowing the first light beam to pass therethrough and reflecting the second light beam.

In some embodiments, the phosphor layer is excited by a first light beam with a first waveband to provide a second light beam with a second waveband, in which the optical layer is used for reflecting the first light beam and the second light beam.

In some embodiments, the second optical unit further includes an anti-reflection (AR) layer. The AR layer and the phosphor layer are respectively disposed at two opposite sides of the transparent substrate.

In some embodiments, the optical layer is configured to at least reflect a light beam having a waveband in a range from about 460 nm to about 700 nm.

An aspect of the present disclosure provides a phosphor wheel including a first optical unit and a second optical unit. The first optical unit includes a substrate and an optical layer. The optical layer is disposed on the substrate. The second optical unit is stacked on the optical layer to produce at least one air medium present between the first optical unit and the second optical unit. The optical layer is configured to at least reflect light beams propagated from the second optical unit. The second optical unit includes a transparent substrate and a phosphor layer, in which the phosphor layer is disposed on the transparent substrate.

In some embodiments, one of the transparent substrate and the phosphor layer of the second optical unit faces the optical layer.

An aspect of the present disclosure provides a wavelength converting device including an actuator and a phosphor wheel. The actuator penetrates the phosphor wheel, and the first optical unit and the second optical unit are connected to the actuator.

### BRIEF DESCRIPTION OF THE DRAWINGS

FIG. 1A is a perspective view of a wavelength converting device according to a first embodiment of the present disclosure;

FIG. 1B is a cross-section diagram of a phosphor wheel of the wavelength converting device taken along the line B-B′ of FIG. 1A;

FIG. 2 is a cross-sectional view of a phosphor wheel with the same cross-section as FIG. 1B according to a second embodiment of the present disclosure;

FIG. 3 is a cross-sectional view of a phosphor wheel with the same cross-section as FIG. 1B according to a third embodiment of the present disclosure;

FIG. 4 is a cross-sectional view of a phosphor wheel with the same cross-section as FIG. 1B according to a fourth embodiment of the present disclosure;

FIG. 5 is a cross-sectional view of a phosphor wheel with the same cross-section as FIG. 1B according to a fifth embodiment of the present disclosure; and

FIGS. 6A and 6B are schematic diagrams of wavelength converting devices applied to light source light modules according to various embodiments of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

It will be understood that, although the terms first, second, third etc. may be used herein to describe various elements, components, regions, layers and/or sections, these elements, components, regions, layers and/or sections should not be limited by these terms.

In order to increase a light emission efficiency of a phosphor wheel of a wavelength converting device, an aspect of the present disclosure provides a wavelength converting device including a first optical unit and a second optical unit. In a configuration of the wavelength converting device, the first optical unit and the second optical unit stacked thereon are fixed by a clamping component to assemble a phosphor wheel, and therefore an air medium is at least present between the second optical unit and an optical layer. With this air medium, the optical layer can have higher reflection efficiency with respect to light beams propagated from the second optical unit, such that a light emission efficiency of the phosphor wheel can be correspondingly increased.

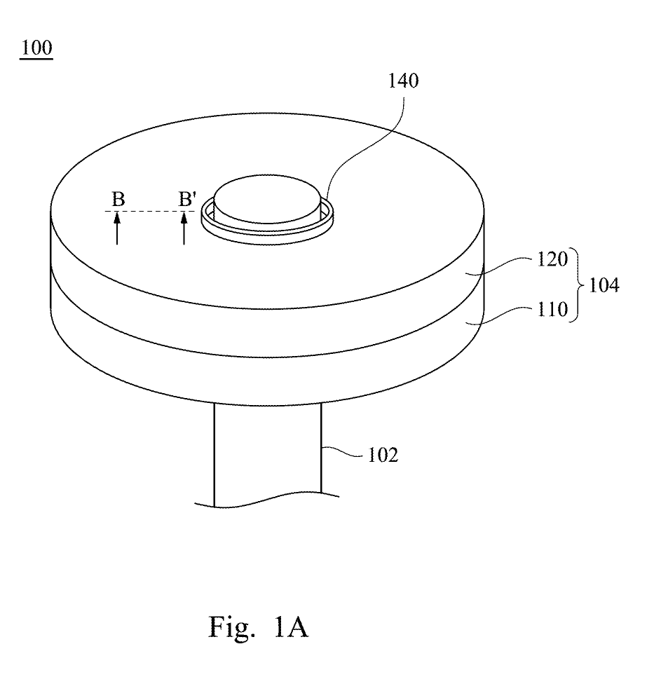

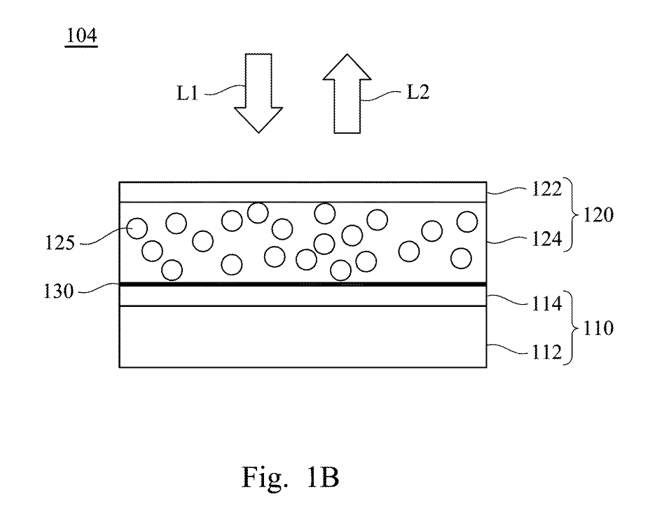

FIG. 1A is a perspective view of a wavelength converting device 100 according to a first embodiment of the present disclosure. FIG. 1B is a cross-section diagram of a phosphor wheel 104 of the wavelength converting device 100 taken along the line B-B′ of FIG. 1A. A wavelength converting device 100 includes an actuator 102 and a phosphor wheel 104. The phosphor wheel 104 includes a first optical unit 110, a second optical unit 120, and a clamping component 140. The actuator 102 penetrates the phosphor wheel 104. The first optical unit 110 and the second optical unit 120 of the phosphor wheel 104 are connected to the actuator 102. Furthermore, a relative position of the first optical unit 110 and the second optical unit 120 is fixed by the clamping component 140. In the present embodiment, the clamping component 140 is a circle ring, but is not limited thereto. The clamping component 140 may be disposed to surround a rotating axle of the actuator 102 and at two opposite sides of a combination of the first optical unit 110 and the second optical unit 120. Thus, the clamping component 140 may be disposed on a bottom surface of the first optical unit 110 and on an upper surface of the second optical unit 120, such that the first optical unit 110 and the second optical unit 120 are held by the clamping component 140.

The first optical unit 110 includes a substrate 112 and an optical layer 114, in which the optical layer 114 is disposed on the substrate 112. The optical layer 114 may be a dielectric coating formed by a multilayer structure. The second optical unit 120 is stacked on the optical layer 114, in which the optical layer 114 is configured to at least reflect light beams propagated from the second optical unit 120. The second optical unit 120 includes a transparent substrate 122 and a phosphor layer 124, in which the phosphor layer 124 is disposed on the transparent substrate 122. In addition, in the present embodiment, the phosphor layer 124 is disposed between the transparent substrate 122 and the optical layer 114.

In some embodiments, coating the optical layer 114 on the substrate 112 can form the first optical unit 110. The second optical unit 120 can be formed by coating or painting the phosphor layer 124 on the transparent substrate 122. Explained in a different way, in a configuration of the phosphor wheel 104, the first optical unit 110 and the second optical unit 120 can be respectively formed first. Next, the second optical unit 120 is stacked on the first optical unit 110, and the combination of the first optical unit 110 and the second optical unit 120 is fixed by the clamping component 140. Since the combination of the first optical unit 110 and the second optical unit 120 is fixed by a clamping effect provided by the clamping component 140, at least one part of a surface of the first optical unit 110 and at least one part of a surface of the second optical unit 120 facing each other can be directly connected with or contacted by each other. In other words, with this configuration, at least one air medium 130 is present between the first optical unit 110 and the second optical unit 120.

In the present embodiment, when the optical layer 114 reflects light beams propagated from the second optical unit 120, reflection efficiency of the optical layer 114 with respect to the light beams is varied according to a boundary condition of a medium at the light incident interface. Thus, reflection spectrum of the optical layer 114 is varied with a refractive index of a medium on the light incident surface. For example, the reflection spectrum of the optical layer 114 under a condition that the refractive index of the medium is one (for example, a refractive index of air is one) is different from the reflection spectrum of the optical layer 114 under a condition that the refractive index of the medium is greater than one. Furthermore, when a waveband of an incident light beam entering the optical layer 114 ranges within a visible spectrum, the reflection efficiency of the optical layer 114 under the condition that the refractive index of the medium is one (for example, a refractive index of air is one) is greater than the reflection efficiency of the optical layer 114 under the condition that the refractive index of the medium is greater than one. Moreover, when a light beam emitted by the second optical unit 120 with a great angle reaches the air medium 130, a probability that the light beam with the great angle enters the optical layer 114 is reduced due to total internal reflection (TIR) occurring at an interface between the second optical unit 120 and the air medium 130. More specifically, if the air medium 130 is not present, the optical layer 114 will reflect the light beam emitted by the second optical unit 120 with the great angle. Since the optical layer 114 made of the dielectric coating is not easy to be designed to reflect a light beam with a greater angle (i.e., a reflectivity of the optical layer 114 with respect to a light beam with a great angle is less than a reflectivity of the optical layer 114 with respect to a light beam with a small angle), the light beam with the great angle may be absorbed by the substrate 112 and light emission efficiency of the phosphor wheel 104 is reduced.

As previously described, under the configuration of the present embodiment, the air medium 130 is at least present between the first optical unit 110 and the second optical unit 120. Moreover, this air medium 130 is present between the phosphor layer 124 and the optical layer 114. In other words, since a medium on the surface of the optical layer 114 at least has air therein, the optical layer 114 can have higher reflection efficiency with respect to the light beam propagated from the second optical unit 120.

Moreover, when the phosphor layer 124 is excited to emit a light beam, the optical layer 114 reflects the light beam emitted toward the optical layer 114 from the phosphor layer 124. Under the condition in which the medium on the surface of the optical layer 114 at least has the air, the optical layer 114 can have higher reflection efficiency with respect to the light beam propagated from the phosphor layer 124, such that the light emission efficiency of the phosphor wheel 104 is correspondingly increased.

Furthermore, in the present embodiment, after a first light beam L1 with a first waveband excites the phosphor layer 124, the phosphor layer 124 can provide a second light beam L2 with a second waveband. For example, when the phosphor layer 124 has phosphor material 125 made of YAG, the first waveband is in a range from about 300 nm to about 460 nm, and the second waveband is in a range from about 460 nm to about 700 nm. Alternatively, the first light beam L1 belongs to waveband of blue spectrum, and the second light beam L2 belongs to waveband of yellow spectrum. However, the phosphor material 125, the first light beam L1, the second light beam L2 described above are not limited thereto. A person having ordinary skill in the art may choose a proper reflection spectrum of the phosphor material 125 of the phosphor layer 124 to set the first waveband and the second waveband.

The optical layer 114 is used for reflecting the first light beam L1 and the second light beam L2. For example, the optical layer 114 can be a reflective coating, in which the reflective coating may be made of metal, such as silver or aluminum. Alternatively, the reflective coating may include a distributed bragg reflector (DBR).

Under this configuration, the first light beam L1 configured to excite the phosphor layer 124 enters the phosphor wheel 104 from a side of the second optical unit 120 opposite to the first optical unit 110. After the first light beam L1 enters the phosphor wheel 104, the phosphor layer 124 is excited by the first light beam L1 to generate the second light beam L2. Next, the first light beam L1 and the second light beam L2 traveling toward the optical layer 114 are reflected by the optical layer 114 therefrom to travel toward the second optical unit 120. Therefore, the first light beam L1 that passes through the second optical unit 120 and is reflected by the optical layer 114 can enter the phosphor layer 124 again to excite the phosphor material 125 therein.

By disposing the optical layer 114, the first light beam L1 and the second light beam L2 can be controlled to travel along a direction from the optical layer 114 toward the transparent substrate 122 so as to enhance directivity of the light beams provided by the phosphor wheel 104. Furthermore, in the present embodiment, an incident direction of the first light beam L1 entering the phosphor wheel 104 and a traveling direction of the second light beam L2 provided by the phosphor wheel 104 are opposite to each other. Therefore, the phosphor wheel 104 of the present embodiment can be taken as a reflection type phosphor wheel.

In addition, the substrate 112 of the first optical unit 110 may be a sapphire substrate, a glass substrate, a borosilicate glass substrate, a borosilicate float glass substrate, a quartz substrate, or a calcium fluoride substrate. Alternatively, the substrate 112 of the first optical unit 110 may be made of metal, non-metal or a ceramic material. The transparent substrate 122 of the second optical unit 120 may be a sapphire substrate, a glass substrate, a borosilicate glass substrate, a borosilicate float glass substrate, a quartz substrate, or a calcium fluoride substrate. Furthermore, in a configuration of the reflection type phosphor wheel, heat generated by the phosphor layer 124 can be diffused to a surface of the transparent substrate 122 by the transparent substrate 122, thereby reducing the temperature of the second optical unit 120.

As described above, in the configuration of the wavelength converting device of the present disclosure, the first optical unit and the second optical unit stacked thereon are fixed by the clamping component to assemble the phosphor wheel, and therefore the air medium is at least present between the phosphor layer and the optical layer. With this air medium, the optical layer can have the higher reflection efficiency, such that the light emission efficiency of the phosphor wheel can be correspondingly increased. In addition, the first light beam and the second light beam can be controlled to travel along the direction from the optical layer toward the transparent substrate so as to further increase the light emission efficiency of the phosphor wheel.

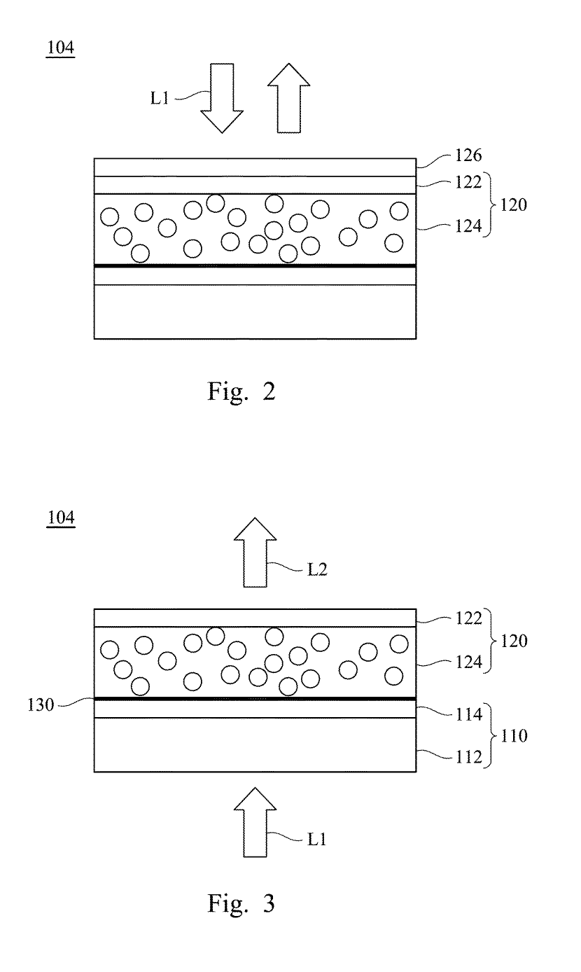

FIG. 2 is a cross-sectional view of a phosphor wheel 104 with the same cross-section as FIG. 1B according to a second embodiment of the present disclosure. The difference between the present embodiment and the first embodiment is that the second optical unit 120 further includes an anti-reflection (AR) layer 126. The AR layer 126 is disposed on a surface of the transparent substrate 122 opposite to the phosphor layer 124, such that the AR layer 126 and the phosphor layer 124 are respectively disposed at two opposite sides of the transparent substrate 122.

In the present embodiment, by disposing the AR layer 126, when the first light beam L1 enters the phosphor wheel 104, the second optical unit 120 can have less reflectivity with respect to the first light beam L1. Therefore, the first light beam L1 can more effectively excite the phosphor layer 124, thereby increasing the light emission efficiency of the phosphor wheel 104.

FIG. 3 is a cross-sectional view of a phosphor wheel 104 with the same cross-section as FIG. 1B according to a third embodiment of the present disclosure. The difference between the present embodiment and the first embodiment is that the optical layer 114 is used for allowing the first light beam L1 to pass therethrough and reflecting the second light beam L2. The optical layer 114 can be a dichroic coating, in which the dichroic coating can be a multilayer coating made of an oxide material.

In the present embodiment, similar to the first embodiment, when the phosphor layer 124 has the phosphor material 125 made of YAG, the first waveband of the first light beam L1 can be in a range from about 300 nm to about 460 nm, and the second waveband of the second light beam L2 can be in a range from about 460 nm to about 700 nm. With the ranges of the first waveband and the second waveband, since the optical layer 114 is configured to at least reflect the light beams propagated from the second optical unit 120, the optical layer 114 can be configured to at least reflect a light beam having a waveband in a range from about 460 nm to about 700 nm. In addition, a person having ordinary skill in the art may choose a proper reflection spectrum of the phosphor material 125 of the phosphor layer 124 to set the first waveband and the second waveband.

With this configuration, the first light beam L1 configured to excite the phosphor layer 124 enters the phosphor wheel 104 from a side of the first optical unit 110 opposite to the second optical unit 120. Thus, the first light beam L1 enters the phosphor wheel 104 via the substrate 112 of the first optical unit 110.

After the first light beam L1 enters the phosphor wheel 104, the first light beam L1 can pass through the optical layer 114 and enter the phosphor layer 124, and the phosphor layer 124 is excited by the first light beam L1 to generate the second light beam L2. When the second light beam L2 generated by the phosphor layer 124 travels toward the optical layer 114, the second light beam L2 traveling toward the optical layer 114 is reflected by the optical layer 114 therefrom, such that traveling directions of the light beams provided by the phosphor wheel 104 can be controlled to the same. Similar to the first embodiment, since the air medium 130 is at least present between the optical layer 114 and the phosphor layer 124, optical layer 114 can have the higher reflection efficiency with respect to the second light beam L2 propagated from the phosphor layer 124, especially the greater angle. Therefore, the light emission efficiency of the phosphor wheel 104 is correspondingly increased.

In addition, an incident direction of the first light beam L1 entering the phosphor wheel 104 is the same as a traveling direction of the second light beam L2 provided by the phosphor 104. Therefore, the phosphor wheel 104 can be taken as a transmission type phosphor wheel. In the transmission type phosphor wheel, the first waveband and the second waveband can be selected to be independent of each other, such that the first light beam L1 and the second light beam L2 are selectively controlled to travel a direction from the optical layer 114 toward the transparent substrate 122 by the optical layer 114.

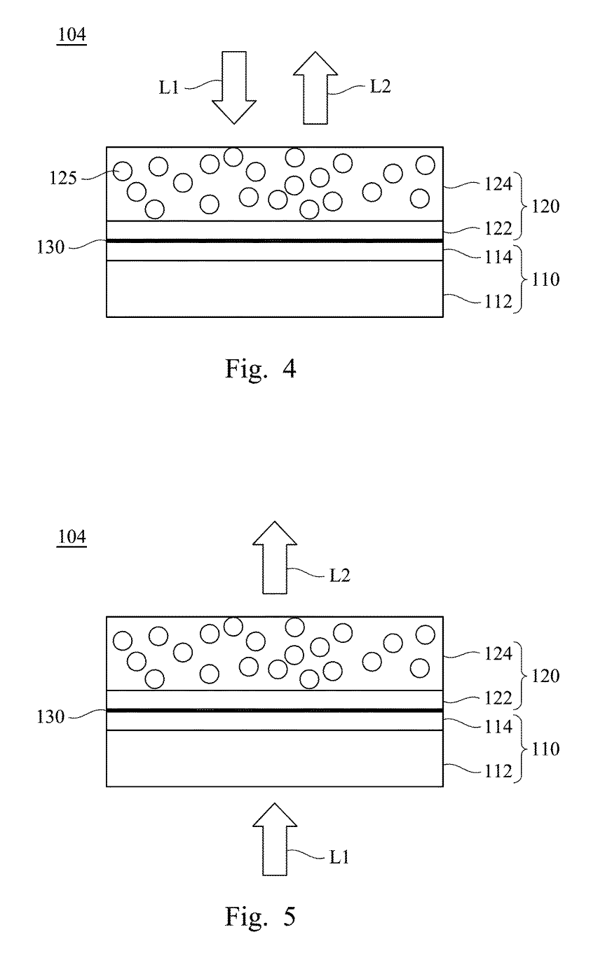

FIG. 4 is a cross-sectional view of a phosphor wheel 104 with the same cross-section as FIG. 1B according to a fourth embodiment of the present disclosure. The difference between the present embodiment and the first embodiment is that the transparent substrate 122 of the second optical unit 120 is disposed between the phosphor layer 124 and the optical layer 114. Furthermore, since the first optical unit 110 and the second optical unit 120 stacked thereon are fixed by the clamping component 140 (see FIG. 1A), the air medium 130 is at least present between the transparent substrate 122 and the optical layer 114. As previously described, under a condition in which the medium present on the surface of the optical layer 114 at least has the air, the optical layer 114 has higher reflection efficiency with respect to the second light beam L2 propagated from the second optical unit 120.

In the present embodiment, the first light beam L1 configured to excite the phosphor layer 124 enters the phosphor wheel 104 from a side of the second optical unit 120 opposite to the first optical unit 110 (i.e., a side opposite to the substrate 112 of the first optical unit 110), and the optical 114 is configured to reflect the first light beam L1 and the second light beam L2 therefrom. Thus, the phosphor wheel 104 of the present embodiment is the reflection type phosphor wheel.

Furthermore, the transparent substrate 122 of the second optical unit 120 faces the optical layer 114, in which a surface of the transparent substrate 122 facing the optical layer 114 is a relatively flat surface (i.e., relative to a surface of the phosphor layer facing the optical layer in the first embodiment to the third embodiment). As previously described, the first light beam L1 passing through the second optical unit 120 and reflected from the optical layer 114 can enter the phosphor 124 again and excite the phosphor material 125 therein. When the first light beam L1 passes through the second optical unit 120 and is reflected from the optical layer 114, since an incident surface of the second optical unit 120 with respect to the first light beam L1 is the relatively flat surface, a situation that the first light beam L1 is reflected back into the optical layer 114 due to light leakage is prevented, thereby increasing a transmission of the first light beam L1 reflected from the optical layer 114 with respect to the second optical unit 120. In addition, a transmission of the second light beam L2 reflected from the optical layer 114 with respect to the second optical unit 120 is increased due to the same mechanism.

FIG. 5 is a cross-sectional view of a phosphor wheel 104 with the same cross-section as FIG. 1B according to a fifth embodiment of the present disclosure. The difference between the present embodiment and the fourth embodiment is that the optical layer 114 of the present embodiment is used for allowing the first light beam L1 to pass therethrough and reflecting the second light beam L2, in which the optical layer 114 can be the dichroic coating.

With this configuration, the phosphor wheel 104 of the present embodiment is the reflection type phosphor wheel, and the first light beam L1 configured to excite the phosphor layer 124 enters the phosphor wheel 104 from a side of the first optical unit 110 opposite to the second optical unit 120. Thus, the first light beam L1 enters the phosphor wheel 104 through the substrate 112 of the first optical unit 110. As previously described, the first waveband of the first light beam L1 and the second waveband of the second light beam L2 can be selected to be independent of each other, such that the first light beam L1 and the second light beam L2 are selectively controlled to travel the direction from the optical layer 114 toward the transparent substrate 122 by the optical layer 114.

As previously described, the light emission efficiency of the phosphor wheel 104 is correspondingly increased by the existence of the air medium 130, and the transmissions of the first light beam L1 and the second light beam L2 with respect to the second optical unit 120 are increased through the relatively flat surface of the transparent substrate 122 facing the optical layer 114.

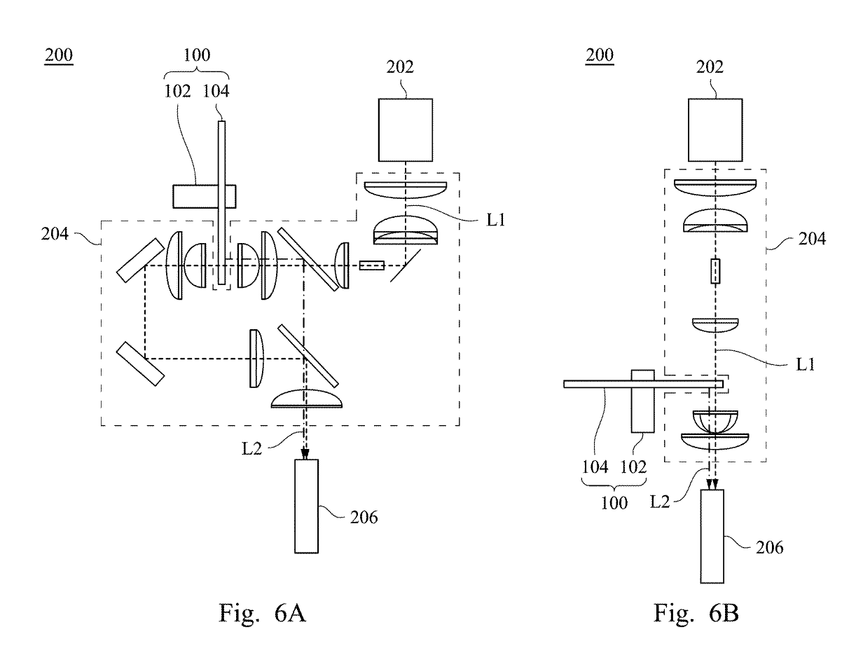

FIGS. 6A and 6B are schematic diagrams of wavelength converting devices 100 applied to light source light modules 200 according to various embodiments of the present disclosure. A light source light module 200 includes a wavelength converting device 100, an excitation light source 202, a light-guiding unit 204, and a light-receiving unit 206. The wavelength converting device 100 includes an actuator 102 and a phosphor wheel 104. The wavelength converting device 100 illustrated in FIG. 6A is the reflection type phosphor wheel, and the wavelength converting device 100 illustrated in FIG. 6B is the transmission type phosphor wheel.

The excitation light source 202 is configured to excite the phosphor wheel 104 of the wavelength converting device 100. The light-guiding unit 204 is configured to guide the first light beam L1 and the second light beam L2 to the light-receiving unit 206. The light-receiving unit 206 is configured to receive the first light beam L1 and the second light beam L2 and to guide the first light beam L1 and the second light beam L2 to an external element (not illustrated). For example, the external element is a color wheel. As previously described, since the light emission efficiency of the phosphor wheel 104 of the wavelength converting device 100 of the present disclosure can be increased by the air medium 130 (see FIG. 1B) therein, a light emission efficiency of the light source light module 200 applying the wavelength converting device 100 is correspondingly increased.

In addition, in the configuration of the reflection type phosphor wheel, the light-guiding unit 204 can be configured to guide the first light beam L1 passing through the phosphor wheel 104, such that the first light beam L1 passing through the phosphor wheel 104 can be guided to the light-receiving unit 206.

As described above, in the configuration of the wavelength converting device of the present disclosure, the first optical unit and the second optical unit stacked thereon are fixed by the clamping component to assemble the phosphor wheel, and therefore the air medium is at least present between the second optical unit and the optical layer. With this air medium, the optical layer can have the higher reflection efficiency with respect to the light beams propagated from the second optical unit, such that the light emission efficiency of the phosphor wheel can be correspondingly increased. In addition, since the phosphor wheel of the wavelength converting device includes the reflection type and the transmission type, the light source light module applying the wavelength converting device of the present disclosure can be arrangement with higher flexibility.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the invention. In view of the foregoing, it is intended that the present disclosure cover modifications and variations of the present disclosure provided they fall within the scope of the following claims.

What is claimed is:

1. A phosphor wheel, comprising:
a first optical unit, comprising:
a substrate; and
an optical layer disposed on the substrate;
a second optical unit stacked on the optical layer, wherein the optical layer is configured to at least reflect light beams propagated from the second optical unit, and the second optical unit comprises:
a transparent substrate; and
a phosphor layer disposed on the transparent substrate; and
a clamping component, wherein the first optical unit and the second optical unit are fixed by the clamping component.

2. The phosphor wheel of claim 1, wherein the transparent substrate is disposed between the phosphor layer and the optical layer.

3. The phosphor wheel of claim 2, wherein the phosphor layer is excited by a first light beam with a first waveband to provide a second light beam with a second waveband, and the optical layer is used for allowing the first light beam to pass therethrough and reflecting the second light beam.

4. The phosphor wheel of claim 2, wherein the phosphor layer is excited by a first light beam with a first waveband to provide a second light beam with a second waveband, and the optical layer is used for reflecting the first light beam and the second light beam.

5. The phosphor wheel of claim 1, wherein the phosphor layer is disposed between the transparent substrate and the optical layer.

6. The phosphor wheel of claim 5, wherein the phosphor layer is excited by a first light beam with a first waveband to provide a second light beam with a second waveband, and the optical layer is used for allowing the first light beam to pass therethrough and reflecting the second light beam.

7. The phosphor wheel of claim 5, wherein the phosphor layer is excited by a first light beam with a first waveband to provide a second light beam with a second waveband, and the optical layer is used for reflecting the first light beam and the second light beam.

8. The phosphor wheel of claim 5, wherein the second optical unit further comprises an anti-reflection (AR) layer, and the AR layer and the phosphor layer are respectively disposed at two opposite sides of the transparent substrate

9. The phosphor wheel of claim 1, wherein the optical layer is configured to at least reflect a light beam having a waveband in a range from about 460 nm to about 700 nm.

10. A phosphor wheel, comprising:
a first optical unit, comprising:
a substrate; and
an optical layer disposed on the substrate; and
a second optical unit stacked on the optical layer to produce at least one air medium present between the first optical unit and the second optical unit, wherein the optical layer is configured to at least reflect light beams propagated from the second optical unit, and the second optical unit comprises:
a transparent substrate; and
a phosphor layer disposed on the transparent substrate.

11. The phosphor wheel of claim 10, wherein one of the transparent substrate and the phosphor layer of the second optical unit faces the optical layer.

12. A wavelength converting device, comprising:
an actuator; and
a phosphor wheel, comprising:
a first optical unit, comprising:
a substrate; and
an optical layer disposed on the substrate;
a second optical unit stacked on the optical layer, wherein the actuator penetrates the phosphor wheel, and the first optical unit and the second optical unit are connected to the actuator, wherein the optical layer is configured to at least reflect light beams propagated from the second optical unit, and the second optical unit comprises:
a transparent substrate; and
a phosphor layer disposed on the transparent substrate; and
a clamping component, wherein the first optical unit and the second optical unit are fixed by the clamping component.

13. The wavelength converting device of claim 12, wherein the transparent substrate is disposed between the phosphor layer and the optical layer.

14. The wavelength converting device of claim 13, wherein the phosphor layer is excited by a first light beam with a first waveband to provide a second light beam with a second waveband, and the optical layer is used for allowing the first light beam to pass therethrough and reflecting the second light beam.

15. The wavelength converting device of claim 13, wherein the phosphor layer is excited by a first light beam with a first waveband to provide a second light beam with a second waveband, and the optical layer is used for reflecting the first light beam and the second light beam.

16. The wavelength converting device of claim 12, wherein the phosphor layer is disposed between the transparent substrate and the optical layer.

17. The wavelength converting device of claim 16, wherein the phosphor layer is excited by a first light beam with a first waveband to provide a second light beam with a second waveband, and the optical layer is used for allowing the first light beam to pass therethrough and reflecting the second light beam.

18. The wavelength converting device of claim 16, wherein the phosphor layer is excited by a first light beam with a first waveband to provide a second light beam with a second waveband, and the optical layer is used for reflecting the first light beam and the second light beam.

19. The wavelength converting device of claim 16, wherein the second optical unit further comprises an anti-reflection (AR) layer, and the AR layer and the phosphor layer are respectively disposed at two opposite sides of the transparent substrate

20. The wavelength converting device of claim 12, wherein the optical layer is configured to at least reflect a light beam having a waveband in a range from about 460 nm to about 700 nm.
